(19) United States
(12) Patent Application Publication
(10) Pub. No.: US 2016/0202811 A1
(43) Pub. Date: Jul. 14, 2016

(54) METHOD OF FABRICATING ELECTRICALLY ISOLATED CONDUCTORS USING FLEXOGRAPHIC VOIDING

(71) Applicant: Uni-Pixel Displays, Inc., The Woodlands, TX (US)

(72) Inventor: Kenneth B. Frame, Spring, TX (US)

(21) Appl. No.: 14/594,804

(22) Filed: Jan. 12, 2015

(51) Int. Cl. G06F 3/047; G09G 5/00

(52) U.S. Cl. CPC G06F 3/047; G09G 5/003; G09G 2300/04

(57) ABSTRACT

A method of fabricating isolated conductors using flexographic voiding includes disposing a base pattern of catalytic material on a substrate, flexographically printing a void pattern of dielectric ink that resists metallization on a portion of the base pattern, and metallizing exposed portions of the catalytic material that are not covered by the dielectric ink.

### BACKGROUND OF THE INVENTION

A touch screen enabled system allows a user to control various aspects of the system by touch or gestures on the screen. A user may interact directly with one or more objects depicted on a display device by touch or gestures that are sensed by a touch sensor. The touch sensor typically includes a conductive pattern disposed on a substrate configured to sense touch. Touch screens are commonly used in consumer, commercial, and industrial systems.

### BRIEF SUMMARY OF THE INVENTION

According to one aspect of one or more embodiments of the present invention, a method of fabricating isolated conductors using flexographic voiding includes disposing a base pattern of catalytic material on a substrate, flexographically printing a void pattern of dielectric ink that resists metallization on a portion of the base pattern, and metallizing exposed portions of the catalytic material that are not covered by the dielectric ink.

Other aspects of the present invention will be apparent from the following description and claims.

### BRIEF DESCRIPTION OF THE DRAWINGS

FIG. 1 shows a cross section of a touch screen in accordance with one or more embodiments of the present invention.

FIG. 2 shows a schematic view of a touch screen enabled system in accordance with one or more embodiments of the present invention.

FIG. 3 shows a functional representation of a touch sensor as part of a touch screen in accordance with one or more embodiments of the present invention.

FIG. 4 shows a cross-section of a touch sensor with conductive patterns disposed on opposing sides of a transparent substrate in accordance with one or more embodiments of the present invention.

FIG. 5A shows a first conductive pattern disposed on a transparent substrate in accordance with one or more embodiments of the present invention.

FIG. 5B shows a zoomed in portion of the first conductive pattern of FIG. 5A in accordance with one or more embodiments of the present invention.

FIG. 6A shows a second conductive pattern disposed on a transparent substrate in accordance with one or more embodiments of the present invention.

FIG. 6B shows a zoomed in portion of the second conductive pattern of FIG. 6A in accordance with one or more embodiments of the present invention.

FIG. 7 shows a portion of a touch sensor in accordance with one or more embodiments of the present invention.

FIG. 8 shows a flexographic printing station in accordance with one or more embodiments of the present invention.

FIG. 9 shows a multi-station flexographic printing system in accordance with one or more embodiments of the present invention.

FIG. 10A shows a portion of a pre-metallized image of a conductive pattern disposed on a substrate in accordance with one or more embodiments of the present invention.

FIG. 10B shows a portion of a flexographically printed void pattern of dielectric ink in accordance with one or more embodiments of the present invention.

FIG. 10C shows a portion of a metallized conductive pattern with electrically isolated conductive channels in accordance with one or more embodiments of the present invention.

FIG. 11A shows a portion of a pre-metallized base pattern in accordance with one or more embodiments of the present invention.

FIG. 11B shows a portion of a pre-metallized base pattern with a flexographically printed void pattern of dielectric ink in accordance with one or more embodiments of the present invention.

FIG. 11C shows a portion of a metallized conductive pattern with electrically isolated interconnect conductive lines in accordance with one or more embodiments of the present invention.

FIG. 12A shows a portion of a pre-metallized image of a conductive pattern disposed on a substrate in accordance with one or more embodiments of the present invention.

FIG. 12B shows a portion of a flexographically printed void pattern of dielectric ink in accordance with one or more embodiments of the present invention.

FIG. 12C shows a portion of a metallized conductive pattern with an electrically isolated dummy portion in accordance with one or more embodiments of the present invention.

FIG. 13 shows a method of fabricating electrically isolated conductors using flexographic voiding in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

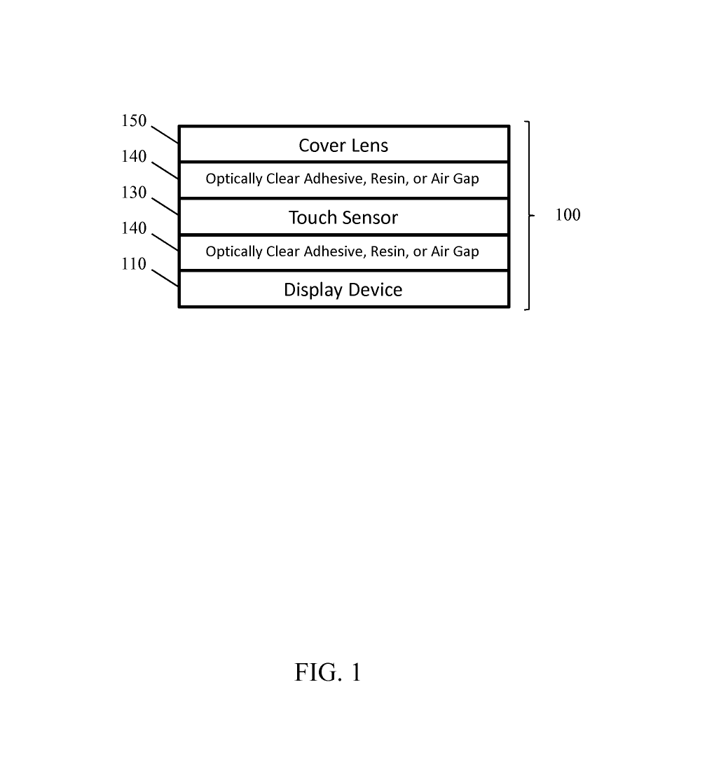

FIG. 1 shows a cross-section of a touch screen 100 in accordance with one or more embodiments of the present invention. Touch screen 100 includes a display device 110. Display device 110 may be a Liquid Crystal Display (“LCD”), Light-Emitting Diode (“LED”), Organic Light-Emitting Diode (“OLED”), Active Matrix Organic Light-Emitting Diode (“AMOLED”), In-Plane Switching (“IPS”), or other type of display device suitable for use as part of a touch screen application or design. In one or more embodiments of the present invention, touch screen 100 may include a touch sensor 130 that overlays at least a portion of a viewable area of display device 110. The viewable area of display device 110 may include the area defined by the light emitting pixels (not shown) of the display device 110 that are typically viewable to an end user. In certain embodiments, an optically clear adhesive or resin 140 may bond a bottom side of touch sensor 130 to a top, or user-facing, side of display device 110. In other embodiments, an isolation layer, or air gap, 140 may separate the bottom side of touch sensor 130 from the top, or user-facing, side of display device 110. A cover lens 150 may overlay a top, or user-facing, side of touch sensor 130. Cover lens 150 may be composed of glass, plastic, film, or other material. In certain embodiments, an optically clear adhesive or resin 140 may bond a bottom side of cover lens 150 to the top, or user-facing, side of touch sensor 130. In other embodiments, an isolation layer, or air gap, 140 may separate the bottom side of cover lens 150 and the top, or user-facing, side of touch sensor 130. A top side of cover lens 150 may face the user and protect the underlying components of touch screen 100. In one or more embodiments of the present invention, touch sensor 130, or the function that it implements, may be integrated into the display device 110 stack (not independently illustrated). One of ordinary skill in the art will recognize that touch sensor 130 may be a capacitive, resistive, optical, acoustic, or any other type of touch sensor technology capable of sensing touch. One of ordinary skill in the art will also recognize that the components or the stackup of touch screen 100 may vary based on an application or design.

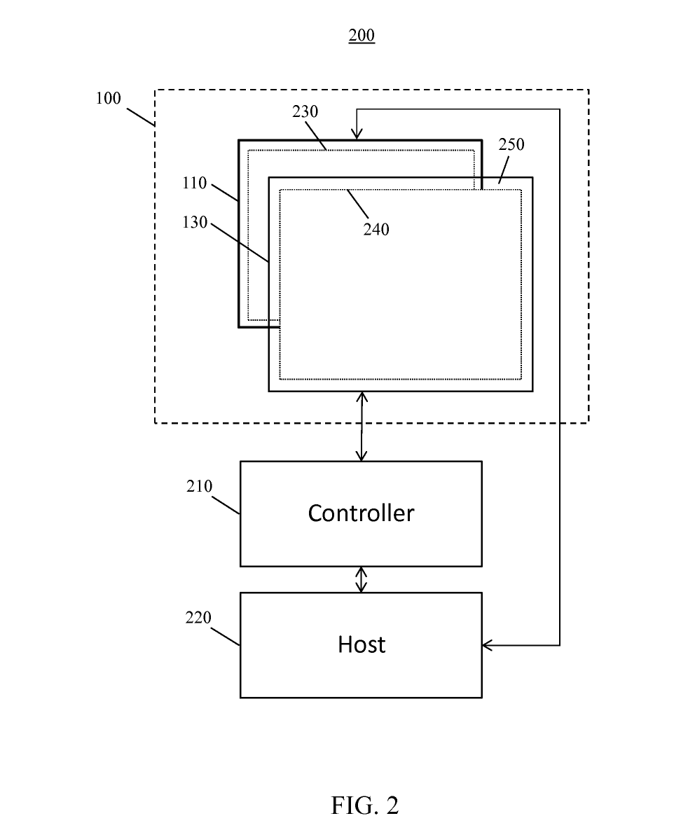

FIG. 2 shows a schematic view of a touch screen enabled system 200 in accordance with one or more embodiments of the present invention. System 200 may be a consumer system, commercial system, or industrial system including, but not limited to, a smartphone, tablet computer, laptop computer, desktop computer, printer, monitor, television, appliance, kiosk, automatic teller machine, copier, desktop phone, automotive display system, portable gaming device, gaming console, or other application or design suitable for use with touch screen 100.

System 200 may include one or more printed circuit boards or flex circuits (not shown) on which one or more processors (not shown), system memory (not shown), and other system components (not shown) may be disposed. Each of the one or more processors may be a single-core processor (not shown) or a multi-core processor (not shown) capable of executing software instructions. Multi-core processors typically include a plurality of processor cores disposed on the same physical die (not shown) or a plurality of processor cores disposed on multiple die (not shown) disposed within the same mechanical package (not shown). System 200 may include one or more input/output devices (not shown), one or more local storage devices (not shown) including solid-state memory, a fixed disk drive, a fixed disk drive array, or any other non-transitory computer readable medium, a network interface device (not shown), and/or one or more network storage devices (not shown) including a network-attached storage device and a cloud-based storage device.

In certain embodiments, touch screen 100 may include touch sensor 130 that overlays at least a portion of a viewable area 230 of display device 110. Touch sensor 130 may include a viewable area 240 that corresponds to that portion of the touch sensor 130 that overlays the light emitting pixels (not shown) of display device 110. Touch sensor 130 may include a bezel circuit 250 outside at least one side of the viewable area 240 that provides connectivity between touch sensor 130 and a controller 210. In other embodiments, touch sensor 130, or the function that it implements, may be integrated into display device 110 (not independently illustrated). Controller 210 electrically drives at least a portion of touch sensor 130. Touch sensor 130 senses touch (capacitance, resistance, optical, acoustic, or other technology) and conveys information corresponding to the sensed touch to controller 210.

The manner in which the sensing of touch is measured, tuned, and/or filtered may be configured by controller 210. In addition, controller 210 may recognize one or more gestures based on the sensed touch or touches. Controller 210 provides host 220 with touch or gesture information corresponding to the sensed touch or touches. Host 220 may use this touch or gesture information as user input and respond in an appropriate manner. In this way, the user may interact with system 200 by touch or gestures on touch screen 100. In certain embodiments, host 220 may be the one or more printed circuit boards or flex circuits (not shown) on which the one or more processors (not shown) are disposed. In other embodiments, host 220 may be a subsystem or any other part of system 200 that is configured to interface with display device 110 and controller 210. One of ordinary skill in the art will recognize that the components and configuration of the components of system 200 may vary based on an application or design in accordance with one or more embodiments of the present invention.

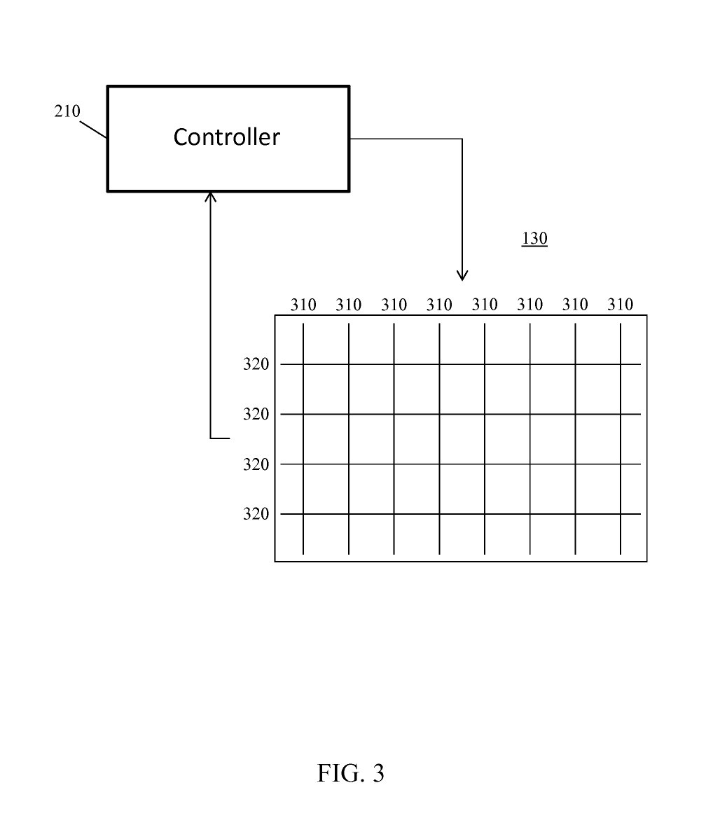

FIG. 3 shows a functional representation of a touch sensor 130 as part of a touch screen 100 in accordance with one or more embodiments of the present invention. In certain embodiments, touch sensor 130 may be viewed as a plurality of column channels 310 and a plurality of row channels 320 arranged as a mesh grid. The number of column channels 310 and the number of row channels 320 may not be the same and may vary based on an application or a design. The apparent intersections of column channels 310 and row channels 320 may be viewed as uniquely addressable locations of touch sensor 130. In operation, controller 210 may electrically drive one or more row channels 320 and touch sensor 130 may sense touch on one or more column channels 310 that are sampled by controller 210. One of ordinary skill in the art will recognize that the role of row channels 320 and column channels 310 may be reversed such that controller 210 electrically drives one or more column channels 310 and touch sensor 130 senses touch on one or more row channels 320 that are sampled by controller 210.

In certain embodiments, controller 210 may interface with touch sensor 130 by a scanning process. In such an embodiment, controller 210 may electrically drive a selected row channel 320 (or column channel 310) and sample all column channels 310 (or row channels 320) that intersect the selected row channel 320 (or the selected column channel 310) by sensing, for example, changes in capacitance at each intersection. This process may be continued through all row channels 320 (or all column channels 310) such that capacitance is measured at each uniquely addressable location of touch sensor 130 at predetermined intervals. Controller 210 may allow for the adjustment of the scan rate depending on the needs of a particular application or design. One of ordinary skill in the art will recognize that the scanning process discussed above may also be used with other touch sensor technologies in accordance with one or more embodiments of the present invention. In other embodiments, controller 210 may interface with touch sensor 130 by an interrupt driven process. In such an embodiment, a touch or a gesture generates an interrupt to controller 210 that triggers controller 210 to read one or more of its own registers that store sensed touch information sampled from touch sensor 130 at predetermined intervals. One of ordinary skill in the art will recognize that the mechanism by which touch or gestures are sensed by touch sensor 130 and sampled by controller 210 may vary based on an application or a design in accordance with one or more embodiments of the present invention.

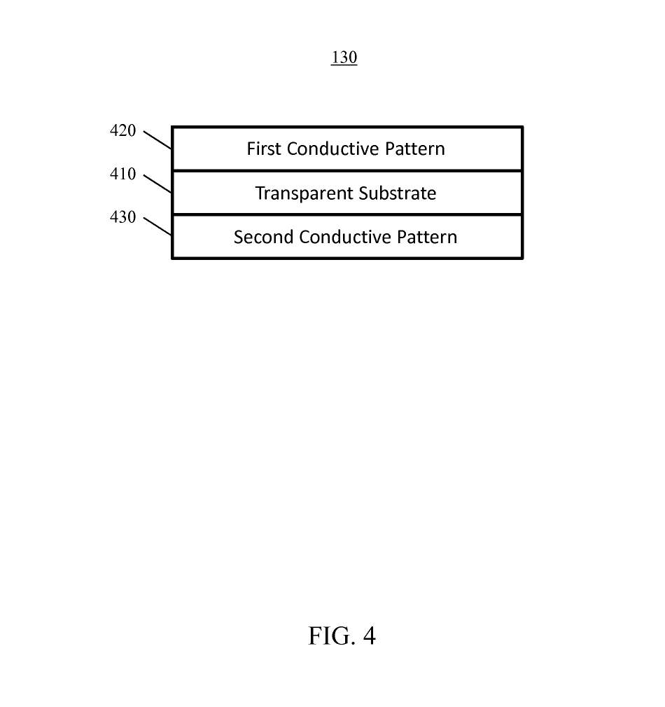

FIG. 4 shows a cross-section of a touch sensor 130 with conductive patterns 420 and 430 disposed on opposing sides of a transparent substrate 410 in accordance with one or more embodiments of the present invention. In certain embodiments, touch sensor 130 may include a first conductive pattern 420 disposed on a top, or user-facing, side of a transparent substrate 410 and a second conductive pattern 430 disposed on a bottom side of the transparent substrate 410. The first conductive pattern 420 may overlay the second conductive pattern 430 at a predetermined alignment that may include an offset. One of ordinary skill in the art will recognize that a conductive pattern may be any shape or pattern of one or more conductors (not shown) in accordance with one or more embodiments of the present invention. One of ordinary skill in the art will also recognize that any type of touch sensor 130 conductor, including, for example, metal conductors, metal mesh conductors, indium tin oxide (“ITO”) conductors, poly(3,4-ethylenedioxythiophene (“PEDOT”) conductors, carbon nanotube conductors, silver nanowire conductors, or any other touch sensor 130 conductors may be used in accordance with one or more embodiments of the present invention.

One of ordinary skill in the art will recognize that other touch sensor 130 stackups (not shown) may be used in accordance with one or more embodiments of the present invention. For example, single-sided touch sensor 130 stackups may include conductors disposed on a single side of a substrate 410 where conductors that cross are isolated from one another by a dielectric material (not shown), such as, for example, as used in On Glass Solution (“OGS”) touch sensor 130 embodiments. Double-sided touch sensor 130 stackups may include conductors disposed on opposing sides of the same substrate 140 (as shown in FIG. 4) or bonded touch sensor 130 embodiments (not shown) where conductors are disposed on at least two different sides of at least two different substrates 410. Bonded touch sensor 130 stackups may include, for example, two single-sided substrates 410 bonded together (not shown), one double-sided substrate 410 bonded to a single-sided substrate 410 (not shown), or a double-sided substrate 410 bonded to another double-sided substrate 410 (not shown). One of ordinary skill in the art will recognize that other touch sensor 130 stackups, including those that vary in the number, the type, the organization, and/or the configuration of substrate(s) and/or conductive pattern(s) are within the scope of one or more embodiments of the present invention. One of ordinary skill in the art will also recognize that one or more of the above-noted touch sensor 130 stackups may be used in applications where touch sensor 130 is integrated into display device 110.

An image of a base pattern, such as, for example, an image of a conductive pattern, may be disposed on one or more transparent substrates 410 by any process suitable for disposing an image of catalytic material on substrate. Suitable processes may include, for example, printing processes, vacuum-based deposition processes, solution coating processes, or cure and etch processes that form seed lines, features, or patterns on substrate that may be further processed to form conductive lines or features on substrate. Printing processes may include flexographic printing of catalytic seed lines, features, or patterns on substrate that are metallized by one or more of an electroless plating process or an immersion plating process, gravure printing, inkjet printing, rotary printing, or stamp printing. Deposition processes may include pattern-based deposition, chemical vapor deposition, electro deposition, epitaxy, physical vapor deposition, or casting. Cure and etch processes may include optical or UV-based photolithography, e-beam/ion-beam lithography, x-ray lithography, interference lithography, scanning probe lithography, imprint lithography, or magneto lithography. One of ordinary skill in the art will recognize that any process or combination of processes suitable for disposing a base pattern of catalytic material on substrate may be used in accordance with one or more embodiments of the present invention.

With respect to transparent substrate 410, transparent means capable of transmitting a substantial portion of visible light through the substrate suitable for a given touch sensor application or design. In certain embodiments, transparent substrate 410 may be polyethylene terephthalate (“PET”), polyethylene naphthalate (“PEN”), cellulose acetate (“TAC”), cycloaliphatic hydrocarbons (“COP”), polymethylmethacrylates (“PMMA”), polyimide (“PI”), bi-axially-oriented polypropylene (“BOPP”), polyester, polycarbonate, glass, copolymers, blends, or combinations thereof. In other embodiments, transparent substrate 410 may be any other transparent material suitable for use as a touch sensor substrate. One of ordinary skill in the art will recognize that the composition of transparent substrate 410 may vary based on an application or design in accordance with one or more embodiments of the present invention.

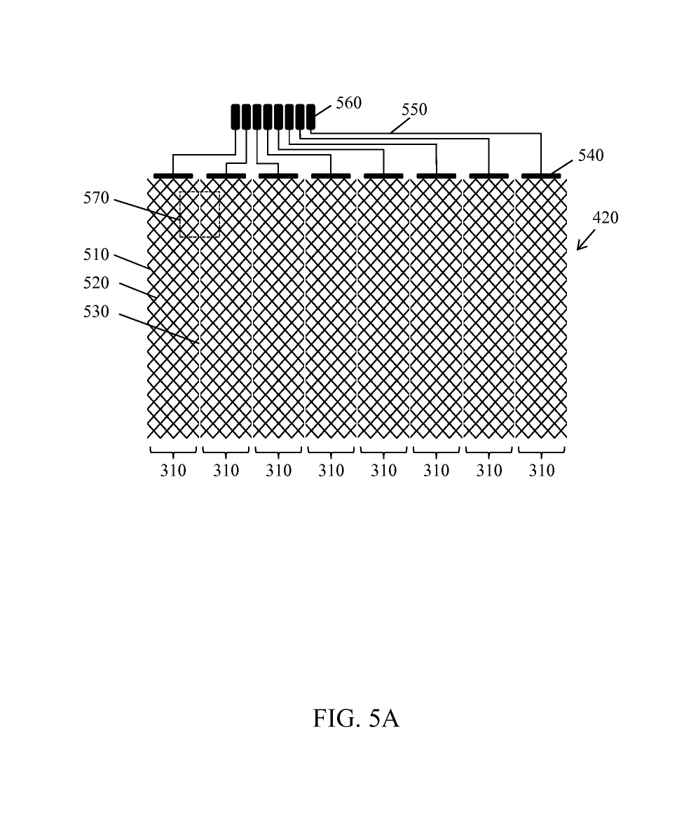

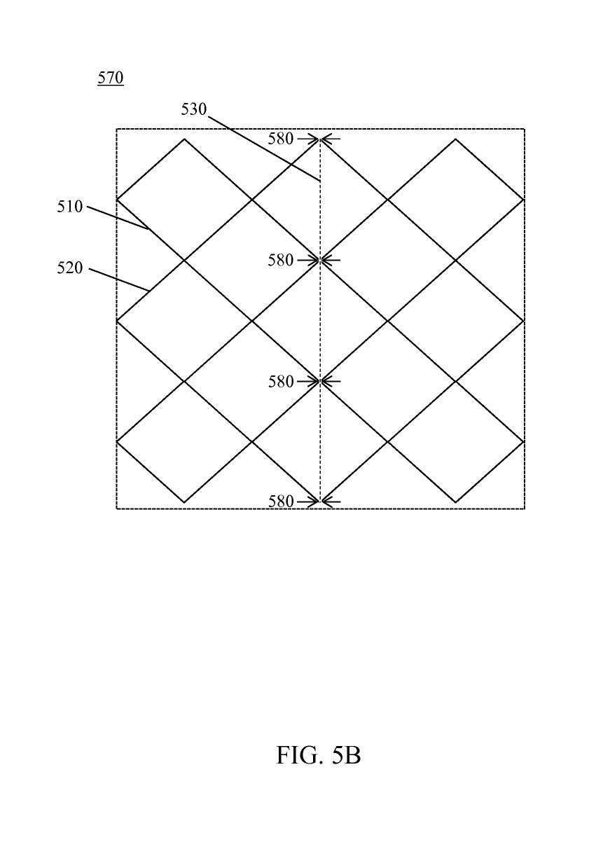

FIG. 5A shows a first conductive pattern 420 disposed on a transparent substrate (e.g., transparent substrate 410) in accordance with one or more embodiments of the present invention. In certain embodiments, first conductive pattern 420 may include a mesh formed by a plurality of parallel conductive lines oriented in a first direction 510 and a plurality of parallel conductive lines oriented in a second direction 520 that are disposed on a side of a transparent substrate (e.g., transparent substrate 410). One of ordinary skill in the art will recognize that the number of parallel conductive lines oriented in the first direction 510 and/or the number of parallel conductive lines oriented in the second direction 520 may vary based on an application or design. One of ordinary skill in the art will also recognize that a size of first conductive pattern 420 may vary based on an application or a design. In other embodiments, first conductive pattern 420 may include any other shape or pattern formed by one or more conductive lines or features (not independently illustrated). One of ordinary skill in the art will recognize that a conductive pattern is not limited to parallel conductive lines and may comprise any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the plurality of parallel conductive lines oriented in the first direction 510 may be perpendicular to the plurality of parallel conductive lines oriented in the second direction 520, thereby forming the mesh. In other embodiments, the plurality of parallel conductive lines oriented in the first direction 510 may be angled (not shown) relative to the plurality of parallel conductive lines oriented in the second direction 520, thereby forming the mesh. One of ordinary skill in the art will recognize that the relative angle between the plurality of parallel conductive lines oriented in the first direction 510 and the plurality of parallel conductive lines oriented in the second direction 520 may vary based on an application or a design in accordance with one or more embodiments of the present invention.

In certain embodiments, a plurality of channel breaks 530 may partition first conductive pattern 420 into a plurality of column channels 310, each electrically isolated from the others. One of ordinary skill in the art will recognize that the number of channel breaks 530 and/or the number of column channels 310 may vary based on an application or design in accordance with one or more embodiments of the present invention. Each column channel 310 may route to a channel pad 540. Each channel pad 540 may route to an interface connector 560 by way of one or more interconnect conductive lines 550. Interface connectors 560 may provide a connection interface between a touch sensor (e.g., 130 of FIG. 1) and a controller (e.g., 210 of FIG. 2).

FIG. 5B shows a zoomed in portion 570 of the first conductive pattern 420 of FIG. 5A. In a conventional touch sensor, each channel break 530 includes a plurality of linearly-aligned non-conductive gaps 580 that span a length of the first conductive pattern 420 and partition it into electrically isolated column channels (e.g., 310 of FIG. 5A). The gaps 580 are devoid of conductive material and there is no conductivity between adjacent conductors on opposing sides of the gaps 580. While each channel break 530 is formed by a plurality of gaps 580, channel break 530 is shown as a dashed line in FIG. 5B to highlight the linearly-aligned shape of the gaps 580.

Because the gaps 580 are linearly-aligned with respect to a vertical axis (vis-à-vis channel break 530) and span at least a significant length (e.g., consecutive gaps 580) of the first conductive pattern 420, channel breaks 530 are discernible to the human eye and render the first conductive pattern 420 more visibly apparent. The human eye tends to integrate or otherwise recognize the pattern of the linearly-aligned gaps 580 as ghost lines as is evident in FIG. 5A. While various aspects of the first conductive pattern 420 may vary based on an application or design, including, for example, the relative angle between the plurality of parallel conductive lines oriented in the first direction 510 and the plurality of parallel conductive lines oriented in the second direction 520, channel breaks 530 remain discernible, regardless of where the channel breaks 530 appear to intersect the parallel conductive lines 510, 520. However, in touch sensor applications, it is desirable to reduce the visibility of the first conductive pattern 420 to an end user. As such, in certain embodiments, it may be desirable to minimize the width of the non-conductive gaps to reduce the appearance of ghost lines that render the first conductive pattern 420 more visibly apparent, while maintaining electrical isolation between column channels 310.

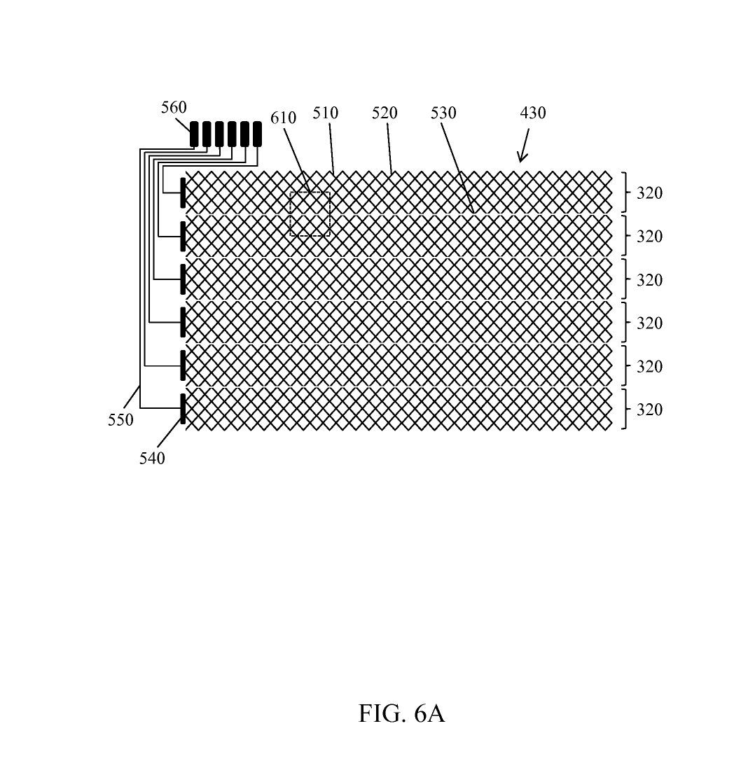

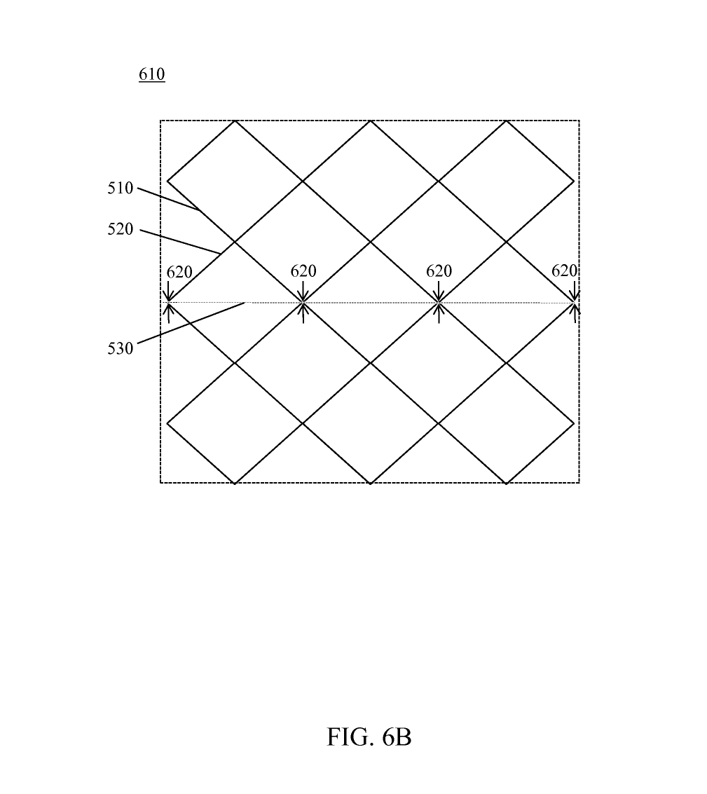

FIG. 6A shows a second conductive pattern 430 disposed on a transparent substrate (e.g., transparent substrate 410) in accordance with one or more embodiments of the present invention. In certain embodiments, second conductive pattern 430 may include a mesh formed by a plurality of parallel conductive lines oriented in a first direction 510 and a plurality of parallel conductive lines oriented in a second direction 520 that are disposed on a side of a transparent substrate (e.g., transparent substrate 410). One of ordinary skill in the art will recognize that the number of parallel conductive lines oriented in the first direction 510 and/or the number of parallel conductive lines oriented in the second direction 520 may vary based on an application or design. The second conductive pattern 430 may be substantially similar in size to the first conductive pattern 420. One of ordinary skill in the art will recognize that a size of the second conductive pattern 430 may vary based on an application or a design. In other embodiments, second conductive pattern 430 may include any other shape or pattern formed by one or more conductive lines or features (not independently illustrated). One of ordinary skill in the art will also recognize that a conductive pattern is not limited to parallel conductive lines and could be any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the plurality of parallel conductive lines oriented in the first direction 510 may be perpendicular to the plurality of parallel conductive lines oriented in the second direction 520, thereby forming the mesh. In other embodiments, the plurality of parallel conductive lines oriented in the first direction 510 may be angled (not shown) relative to the plurality of parallel conductive lines oriented in the second direction 520, thereby forming the mesh. One of ordinary skill in the art will recognize that the relative angle between the plurality of parallel conductive lines oriented in the first direction 510 and the plurality of parallel conductive lines oriented in the second direction 520 may vary based on an application or a design in accordance with one or more embodiments of the present invention.

In certain embodiments, a plurality of channel breaks 530 may partition second conductive pattern 430 into a plurality of row channels 320, each electrically isolated from the others. One of ordinary skill in the art will recognize that the number of channel breaks 530 and/or the number of row channels 320 may vary based on an application or design in accordance with one or more embodiments of the present invention. Each row channel 320 may route to a channel pad 540. Each channel pad 540 may route to an interface connector 560 by way of one or more interconnect conductive lines 550. Interface connectors 560 may provide a connection interface between a touch sensor (e.g., 130 of FIG. 1) and a controller (e.g., 210 of FIG. 2).

FIG. 6B shows a zoomed in portion 610 of the second conductive pattern 430 of FIG. 6A. In a conventional touch sensor, each channel break 530 includes a plurality of linearly-aligned non-conductive gaps 620 that span a width of the second conductive pattern 430 and partition it into electrically isolated row channels (e.g., 320 of FIG. 6A). The gaps 620 are devoid of conductive material and there is no conductivity between adjacent conductors on opposing sides of the gaps 620. While each channel break 530 is formed by a plurality of gaps 620, channel break 530 is shown as a dashed line in FIG. 6B to highlight the linearly-aligned shape of the gaps 620.

Because the gaps 620 are linearly-aligned with respect to a horizontal axis (vis-à-vis channel break 530) and span at least a significant width (e.g., consecutive gaps 580) of the second conductive pattern 430, channel breaks 530 are discernible to the human eye and render the second conductive pattern 430 more visibly apparent. The human eye tends to integrate or otherwise recognize the pattern of the linearly-aligned gaps 620 as ghost lines as is evident in FIG. 6A. While various aspects of the second conductive pattern 430 may vary based on an application or design, including, for example, the relative angle between the plurality of parallel conductive lines oriented in the first direction 510 and the plurality of parallel conductive lines oriented in the second direction 520, channel breaks 530 remain discernible, regardless of where the channel breaks 530 appear to intersect the parallel conductive lines 510, 520. However, in touch sensor applications, it is desirable to reduce the visibility of the second conductive pattern 430 to an end user. As such, in certain embodiments, it may be desirable to minimize the width of the non-conductive gaps to reduce or eliminate the appearance of ghost lines that render the second conductive pattern 430 more visibly apparent, while maintaining electrical isolation between row channels 320.

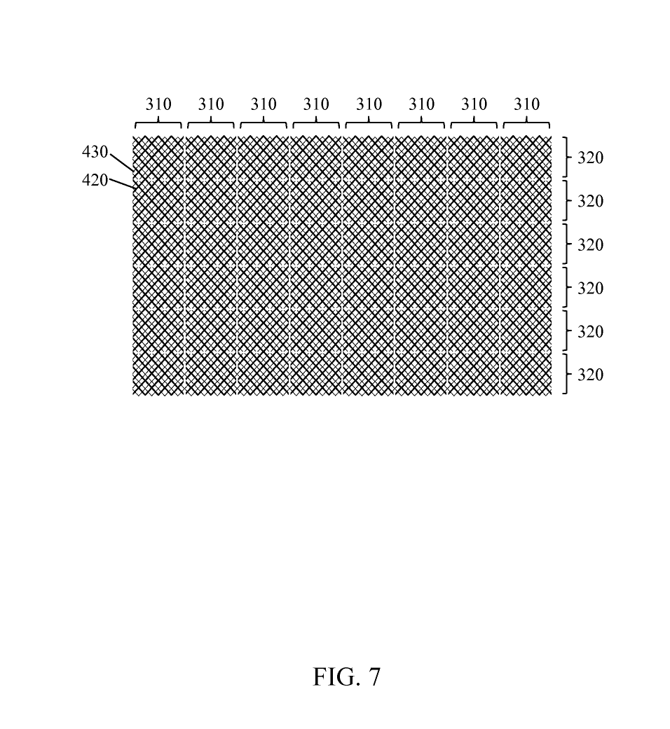

FIG. 7 shows a portion of a touch sensor 130 in accordance with one or more embodiments of the present invention. In certain embodiments, a touch sensor 130 may be formed, for example, by disposing a first conductive pattern 420 on a top, or user-facing, side of a transparent substrate (e.g., transparent substrate 410) and disposing a second conductive pattern 430 on a bottom side of the transparent substrate (e.g., transparent substrate 410). In other embodiments, a touch sensor 130 may be formed, for example, by disposing a first conductive pattern 420 on a side of a first transparent substrate (e.g., transparent substrate 410), disposing a second conductive pattern 430 on a side of a second transparent substrate (e.g., transparent substrate 410), and bonding the first transparent substrate to the second transparent substrate. One of ordinary skill in the art will recognize that the disposition of the conductive pattern or patterns may vary based on the touch sensor 130 stackup in accordance with one or more embodiments of the present invention. In embodiments that use two conductive patterns, the first conductive pattern 420 and the second conductive pattern 430 may be offset vertically, horizontally, and/or angularly relative to one another. The offset between the first conductive pattern 420 and the second conductive pattern 430 may vary based on an application or a design.

In certain embodiments, the first conductive pattern 420 may include a plurality of parallel conductive lines oriented in a first direction (e.g., 510 of FIG. 5A) and a plurality of parallel conductive lines oriented in a second direction (e.g., 520 of FIG. 5A) that form a mesh that is partitioned by a plurality of channel breaks (e.g., 530 of FIG. 5A and FIG. 5B) into electrically partitioned column channels 310. In certain embodiments, the second conductive pattern 430 may include a plurality of parallel conductive lines oriented in a first direction (e.g., 510 of FIG. 6A) and a plurality of parallel conductive lines oriented in a second direction (e.g., 520 of FIG. 6A) that form a mesh that is partitioned by a plurality of breaks (e.g., 530 of FIG. 6A and FIG. 6B) into electrically partitioned row channels 320. In operation, a controller (e.g., 210 of FIG. 2) may electrically drive one or more row channels 320 (or column channels 310) and touch sensor 130 senses touch on one or more column channels 310 (or row channels 320) sampled by the controller. In other embodiments, the disposition and/or the role of the first conductive pattern 420 and the second conductive pattern 430 may be reversed.

In certain embodiments, one or more of the plurality of parallel conductive lines oriented in a first direction (e.g., 510 of FIG. 5A or FIG. 6A), one or more of the plurality of parallel conductive lines oriented in a second direction (e.g., 520 of FIG. 5A or FIG. 6A), one or more of the plurality of channel breaks (e.g., 530 of FIG. 5A, FIG. 5B, FIG. 6A, or FIG. 6B), one or more of the plurality of channel pads (e.g., 540 of FIG. 5A or FIG. 6A), one or more of the plurality of interconnect conductive lines (e.g., 550 of FIG. 5A or FIG. 6A), and/or one or more of the plurality of interface connectors (e.g., 560 of FIG. 5A or FIG. 6A) of the first conductive pattern 420 or second conductive pattern 430 may have different line widths and/or different orientations. In certain embodiments, one or more of the plurality of parallel conductive lines oriented in the first direction and one or more of the plurality of parallel conductive lines oriented in the second direction may have a line width that varies based on an application or design, including, for example, micrometer-fine line widths. In addition, the number of parallel conductive lines oriented in the first direction, the number of parallel conductive lines oriented in the second direction, and the line-to-line spacing between them may vary based on an application or a design. One of ordinary skill in the art will recognize that the size, configuration, and design of each conductive pattern may vary based on an application or a design in accordance with one or more embodiments of the present invention.

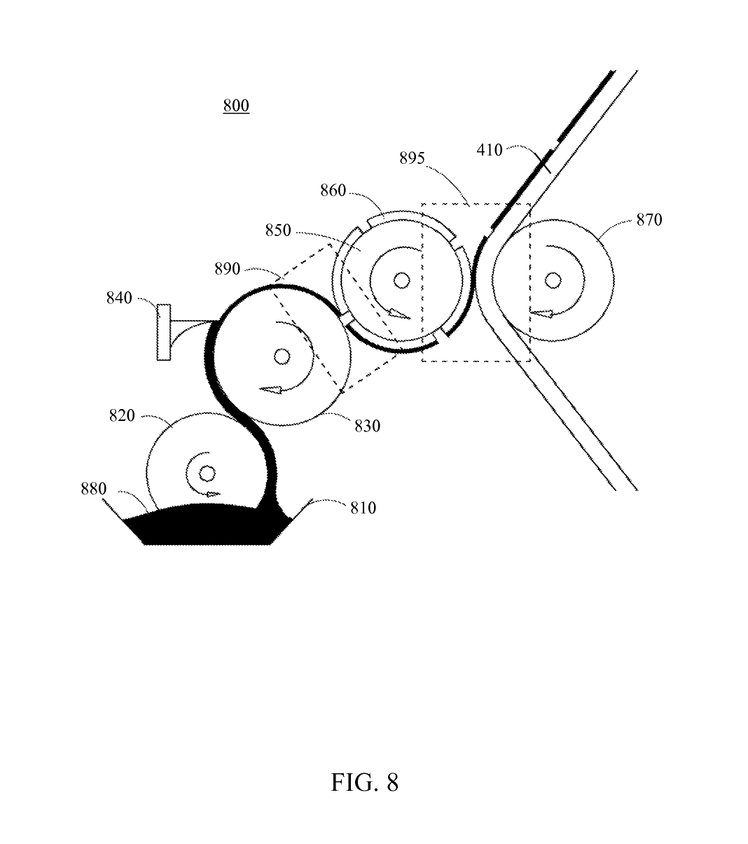

FIG. 8 shows a flexographic printing station 800 in accordance with one or more embodiments of the present invention. Flexographic printing station 800 may include an ink pan 810, an ink roll 820 (also referred to as a fountain roll), an anilox roll 830 (also referred to as a meter roll), a doctor blade 840, a printing plate cylinder 850, a flexographic printing plate 860, and an impression cylinder 870 configured to print on a transparent substrate 410 material that moves through the station 800.

In operation, ink roll 820 rotates transferring ink 880 from ink pan 810 to anilox roll 830. Anilox roll 830 may be constructed of a rigid cylinder that includes a curved contact surface about the body of the cylinder that contains a plurality of dimples, also referred to as cells (not shown), that hold and transfer ink 880. As anilox roll 830 rotates, doctor blade 840 may be used to remove excess ink 880 from anilox roll 830. In transfer area 890, anilox roll 830 rotates transferring ink 880 from some of the cells to flexographic printing plate 860. Flexographic printing plate 860 may include a contact surface formed by distal ends of an image formed in flexographic printing plate 860. The distal ends of the image are inked to transfer an image to transparent substrate 410. The cells may meter the amount of ink 880 transferred to flexographic printing plate 860 to a near uniform volume. In certain embodiments, ink 880 may be a precursor, or catalytic, ink that serves as a plating or buildup seed suitable for metallization by electroless plating or other buildup processes. For example, ink 880 may be a catalytic ink that comprises one or more of silver, nickel, copper, palladium, cobalt, platinum group metals, alloys thereof, or other catalytic particles. In other embodiments, ink 880 may be a conductive ink suitable for direct printing of conductive lines or features on transparent substrate 410. In still other embodiments, ink 880 may be a non-catalytic and non-conductive ink. For example, ink 880 may be a dielectric ink that is not catalytic and is not susceptible to metallization including, for example, electroless plating. One of ordinary skill in the art will recognize that the composition of ink 880 may vary based on an application or a design.

Printing plate cylinder 850 may be constructed of a rigid cylinder composed of a metal, such as, for example, steel. Flexographic printing plate 860 may be mounted to a curved contact surface about the body of printing plate cylinder 850 by an adhesive (not shown). Transparent substrate 410 material moves between counter rotating flexographic printing plate 860 and impression cylinder 870. Impression cylinder 870 may be constructed of a rigid cylinder composed of a metal that may be coated with an abrasion resistant coating. As impression cylinder 870 rotates, it applies pressure between transparent substrate 410 material and flexographic printing plate 860, transferring an ink 880 image from flexographic printing plate 860 onto transparent substrate 410 at transfer area 895. The rotational speed of printing plate cylinder 850 may be synchronized to match the speed at which transparent substrate 410 material moves through flexographic printing system 800. The speed may vary between 20 feet per minute to 3000 feet per minute.

In certain embodiments, one or more flexographic printing stations 800 may be used to print a precursor, or catalytic, ink 880 image (not shown) of one or more conductive patterns (e.g., first conductive pattern 420 or second conductive pattern 430) on one or more sides of one or more transparent substrates 410. Subsequent to flexographic printing, the precursor, or catalytic, ink 880 image (not shown) may be metallized by one or more of an electroless plating process, an immersion bathing process, and/or other buildup processes, forming one or more conductive patterns (e.g., first conductive pattern 420 or second conductive pattern 430) on one or more sides of one or more transparent substrates 410. In other embodiments, one or more flexographic printing stations 800 may be used to directly print a conductive ink 880 image (not shown) of one or more conductive patterns (e.g., first conductive pattern 420 or second conductive pattern 430) on one or more sides of one or more transparent substrates 410.

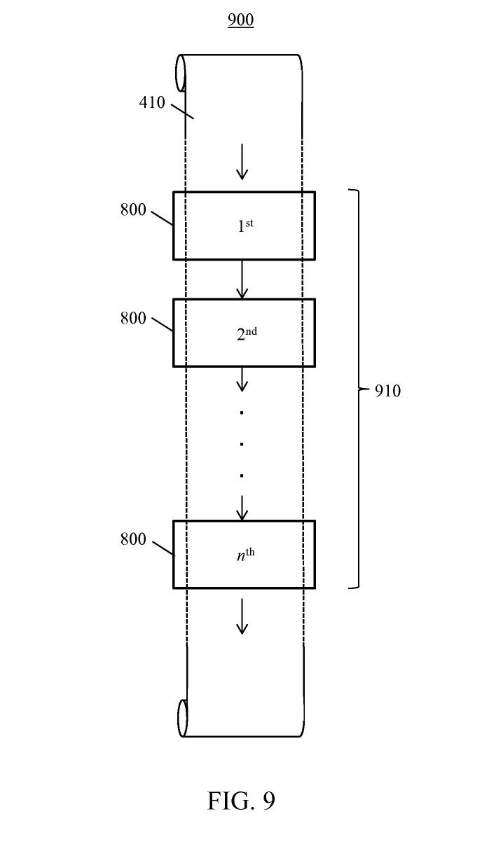

FIG. 9 shows a multi-station flexographic printing system 900 in accordance with one or more embodiments of the present invention. In certain embodiments, a multi-station flexographic printing system 900 may include a plurality 910 of flexographic printing stations 800 that are configured to print on one or more sides of a transparent substrate 410 in sequential order. In applications where the multi-station flexographic printing system 900 is configured to print on opposing sides of the same transparent substrate, one or more of the plurality of flexographic printing stations 800 may be configured to print on a first side of transparent substrate 410 and one or more of the plurality of flexographic printing stations 800 may be configured to print on a second side of transparent substrate 410. In other embodiments, a multi-station flexographic printing system 900 may include a plurality 910 of flexographic printing stations 800 where only a subset of the plurality 910 of flexographic printing stations 800 are configured to print on one or more sides of a transparent substrate 410 in sequential order. One of ordinary skill in the art will recognize that the configuration of multi-station flexographic printing system 900 may vary based on an application or design in accordance with one or more embodiments of the present invention.

Multi-station flexographic printing system 900 may include a number, n, of flexographic printing stations 800 where the number varies based on an application or design. In certain embodiments, a first flexographic printing station (1^{st} 800 of FIG. 9) may be used to print a non-catalytic ink (880 of FIG. 8) image on substrate, in an area outside a designated image area, of, for example, one or more bearer bars (not shown) and/or one or more optical registration marks (not shown) that may be used to control the press during flexographic printing operations. The number, n−1, of subsequent flexographic printing stations (2^{nd} through n^{th} 800 of FIG. 9) may vary based on an application or design. In certain embodiments, the number of subsequent flexographic printing stations 800 may include at least one flexographic printing station 800 for each side of transparent substrate 410 to be printed. In other embodiments, the number of subsequent flexographic printing stations 800 may include a plurality of flexographic printing stations 800 for each side of transparent substrate 410 to be printed. In still other embodiments, the number of subsequent flexographic printing stations 800 may include a plurality of flexographic printing stations 800 for each side of transparent substrate 410 to be printed, where the number of flexographic printing stations 800 for a given side may be determined by the number of micrometer-fine lines or features to be printed having a different width or orientation.

For example, in certain touch sensor embodiments, multi-station flexographic printing system 900 may be configured to print an image of a first conductive pattern (e.g., first conductive pattern 420) on a first side of transparent substrate 410 and an image of a second conductive pattern (e.g., second conductive pattern 430) on a second side of transparent substrate 410. The image of the first conductive pattern may include an image of a plurality of parallel conductive lines oriented in a first direction (e.g., 510 of FIG. 5), an image of a plurality of parallel conductive lines oriented in a second direction (e.g., 520 of FIG. 5), and an image of bezel circuitry (e.g., 540, 550, and 560 of FIG. 5). The image of the second conductive pattern may include an image of a plurality of parallel conductive lines oriented in a first direction (e.g., 510 of FIG. 6), an image of a plurality of parallel conductive lines oriented in a second direction (e.g., 520 of FIG. 6), and an image of bezel circuitry (e.g., 540, 550, and 560 of FIG. 6).

Continuing with the example, a first flexographic printing station (1^{st} 800 of FIG. 9) may be configured to print a non-catalytic ink (880 of FIG. 8) image on a first side of transparent substrate 410, a second flexographic printing station (2^{nd} 800 of FIG. 9), a third flexographic printing station (3^{rd} 800 of FIG. 9), and a fourth flexographic printing station (4^{th} 800 of FIG. 9) may be configured to print a catalytic ink (880 of FIG. 8) image of a first conductive pattern (e.g., first conductive pattern 420) on the first side of transparent substrate 410, and a fifth flexographic printing station (5^{th} 800 of FIG. 9), a sixth flexographic printing station (6^{th} 800 of FIG. 9), and a seventh flexographic printing station (7^{th} 800 of FIG. 9) may be configured to print a catalytic ink (880 of FIG. 8) image of a second conductive pattern (e.g., second conductive pattern 430) on a second side of transparent substrate 410. One of ordinary skill in the art will recognize that the number and configuration of flexographic printing stations 800 of a multi-station flexographic printing system 900 may vary based on an application or design in accordance with one or more embodiments of the present invention.

However, there are a number of issues that arise when fabricating conductors intended for use in a conductive pattern of a touch sensor. As previously discussed, it is desirable to minimize the appearance of the conductive pattern or patterns of the touch sensor. As such, the line width and the line-to-line spacing of the conductors, as well as the design of the conductive pattern itself, may vary based on an application or design in an attempt to reduce the visual appearance of the conductive pattern or patterns of the touch sensor. In addition, the line width and the line-to-line spacing of the conductors, as well as the design of the bezel circuitry itself, may vary based on an application or design in an attempt to provide reliable and fault-tolerant connectivity between the conductive pattern or patterns of the touch sensor and the controller. Thus, an inherent difficulty in fabricating a conductive pattern or bezel circuit of a touch sensor is the ability to fabricate very fine conductive lines or features as well as fine non-conductive areas between conductive lines or features.

Accordingly, in one or more embodiments of the present invention, a method of fabricating electrically isolated conductors using flexographic voiding provides high-resolution non-conductive gaps that are micrometer-fine. The flexographic voiding may be used to create high-resolution channel breaks that reduce the visibility of the channel breaks and the conductive pattern itself. In addition, the flexographic voiding may be used to fabricate isolated conductors in, for example, the bezel circuit of a touch sensor with improved tolerances. The flexographic voiding may also be used to appearance match dummy portions of the conductive pattern that are disconnected from the remainder of the conductive pattern.

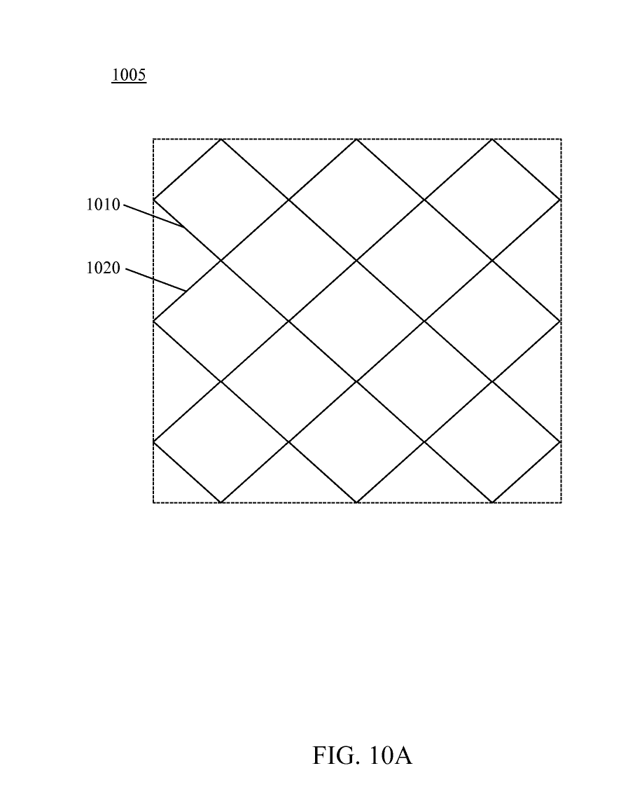

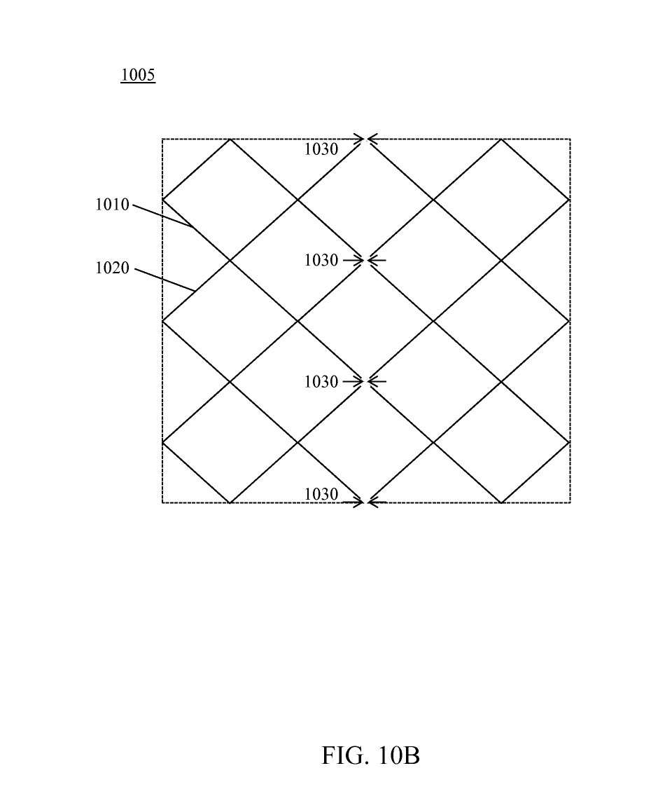

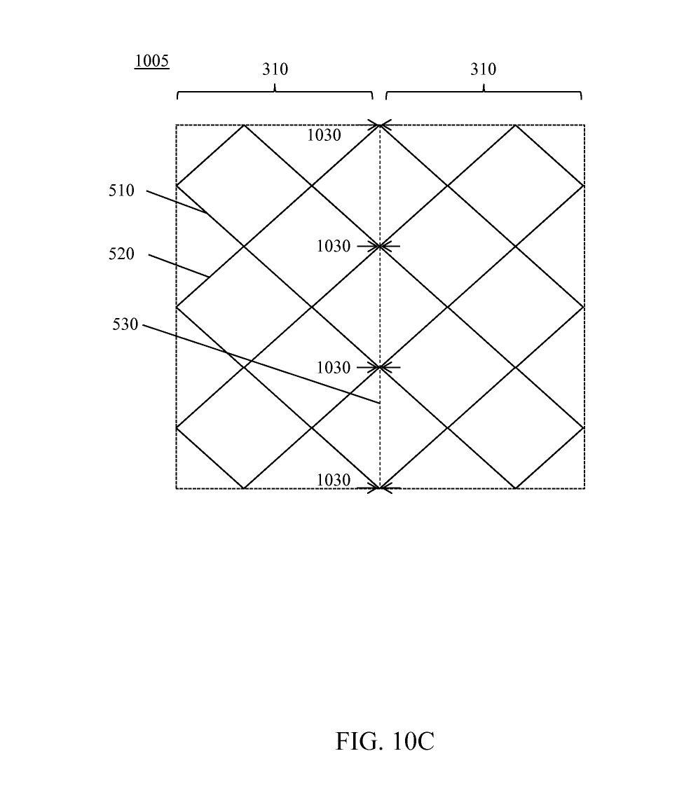

FIG. 10A shows a portion 1005 of a pre-metallized image of a conductive pattern (e.g., first conductive pattern 420) disposed on a substrate (e.g., transparent substrate 410) in accordance with one or more embodiments of the present invention. A pre-metallized image of a conductive pattern, also referred to as a base pattern, may be disposed on a substrate using any process suitable for disposing the image on the substrate, including, for example, a flexographic printing process. In flexographic embodiments, the pre-metallized image may be flexographically printed on the substrate using a catalytic material such as, for example, a precursor or catalytic ink (e.g., ink 880), that may serve as a seed layer for electroless plating, immersion bathing, or other metallization process subsequent to flexographic printing operations. The pre-metallized image of the conductive pattern may include an image 1010 of a plurality of parallel conductive lines oriented in a first direction (e.g., parallel conductive lines 510) and an image 1020 of a plurality of parallel conductive lines oriented in a second direction (e.g., parallel conductive lines 520). One of ordinary skill in the art will recognize that the pre-metallized image of the conductive pattern may vary based on an application or design in accordance with one or more embodiments of the present invention.

Continuing in FIG. 10B, a portion 1005 of a flexographically printed void 1030 pattern of dielectric ink (not independently illustrated) is shown in accordance with one or more embodiments of the present invention. One or more flexographic print stations (e.g., flexographic printing station 800) may be used to print a void 1030 pattern of dielectric ink that resists metallization on at least a portion of the pre-metallized image of the conductive pattern. Each void 1030 may be a line, a square, a rectangle, a polygon, or any other shape that may vary based on an application or design. The size of the void 1030 and the pattern in which they are arranged may also vary based on an application or design. However, in certain embodiments, such as, for example, touch sensor applications, it may be desirable to print voids 1030 having very small feature sizes. For example, in the embodiment depicted in FIG. 10B, the void 1030 pattern may be used to form a channel break (e.g., channel break 530) that partitions the conductive pattern into a plurality of channels (e.g., column channels 310). In such an embodiment, the void 1030 pattern may be designed such that the voids 1030 are printed over one or more intersections formed by the images 1010 and 1020 of one or more parallel conductive lines oriented in the first direction and one or more parallel conductive lines oriented in the second direction. Because the images of the conductive lines are micrometer-fine, the voids 1030 may also be micrometer-fine. Advantageously, the visibility of the voids 1030 may be reduced as their feature size decreases. In certain embodiments, the voids 1030 may have a line width less than 5 micrometers. In other embodiments, the voids 1030 may have a line width in a range between approximately 5 micrometers and approximately 10 micrometers. While an advantage of the flexographically printed voids 1030 is the ability to form high-resolution non-conductive gaps, one of ordinary skill in the art will recognize that the voids could have a line width larger than 10 micrometers that may be used in other applications or designs in accordance with one or more embodiments of the present invention.

In certain embodiments, the void 1030 pattern may be flexographically printed with dielectric ink. One of ordinary skill in the art will recognize that the composition of the dielectric ink may vary based on an application or design and other dielectric inks may be used so long as they resist metallization. Resistance to metallization means that, when the substrate is subjected to a metallization process, including, for example, an electroless plating process, an immersion bathing process, or other metallization process, the voids 1030 prevent the catalytic material, or catalytic ink, on which they are disposed from being metallized. In certain embodiments, the dielectric ink may have a color that matches a color of a metal used to metalize the exposed catalytic material or a final color of the conductive pattern.

Continuing in FIG. 10C, a portion 1005 of a metallized conductive pattern with electrically isolated conductive channels 310 is shown in accordance with one or more embodiments of the present invention. Subsequent to the flexographic printing of the void 1030 pattern, the substrate may be subjected to a metallization process including, for example, an electroless plating process, an immersion bathing process, or other metallization process. The metallization process metallizes the exposed portions of the catalytic material, or catalytic ink, which are not covered by the void 1030 pattern. The voids 1030 prevent the catalytic material, or catalytic ink, on which they are disposed from being metallized. As such, in the embodiment depicted in FIG. 10C, the void 1030 pattern may form a channel break 530 that partitions the conductive pattern into a plurality of column channels 310 that are electrically isolated from each other. While the embodiment depicted in FIG. 10C shows the use of a flexographic void 1030 pattern used to form a channel break 530 partitioning the conductive pattern in column channels 310, one of ordinary skill in the art will recognize that the same process may be used to form channel breaks (e.g., 530 of FIG. 6) that partition a conductive pattern into a plurality of row channels (e.g., row channels 320). Because the dielectric ink was color matched to the color of the metal used to metalize the exposed catalytic material, there is no visible break in the conductive pattern, even though channel break 530 electrically isolates adjacent column channels 310. Thus, the visibility of the channel breaks is reduced or eliminated and the absence of contrast substantially reduces the visibility of the conductive pattern itself.

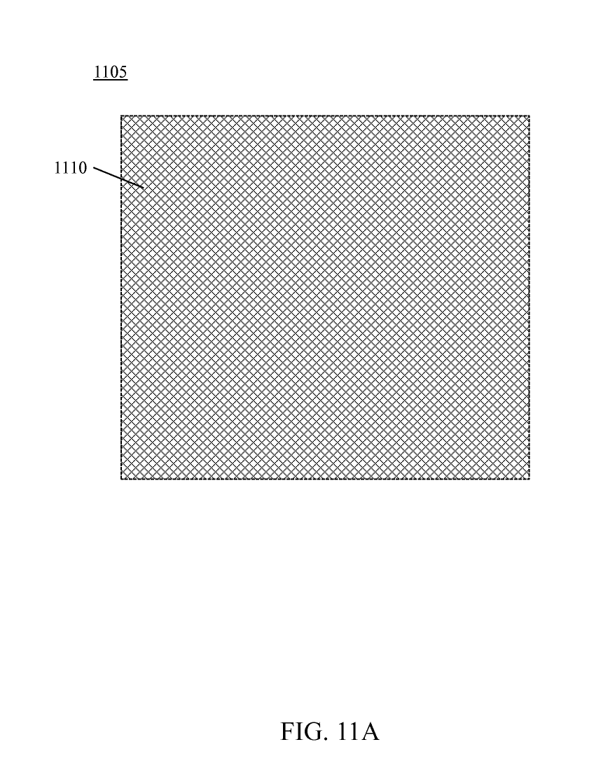

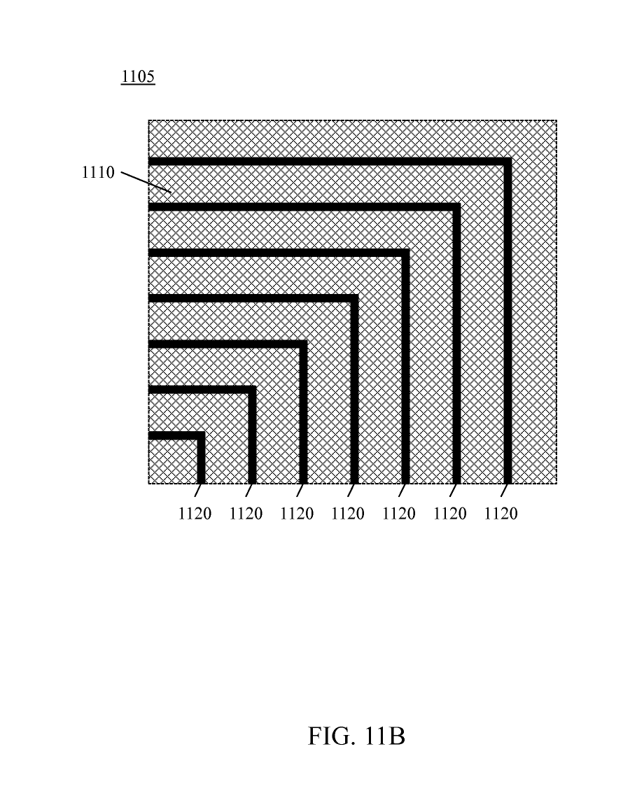

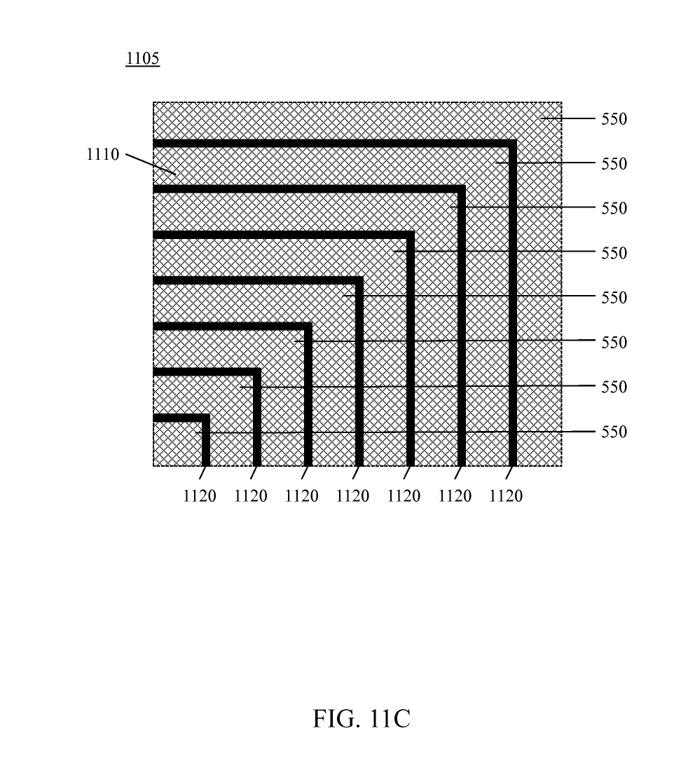

FIG. 11A shows a portion 1105 of a pre-metallized base pattern 1110 in accordance with one or more embodiments of the present invention. A pre-metallized base pattern 1110 may be disposed on a substrate using any process suitable for disposing the pre-metallized base pattern 1110 on the substrate, including, for example, a flexographic printing process. In flexographic embodiments, the pre-metallized base pattern 1110 may be flexographically printed on the substrate using a catalytic material such as, for example, a precursor or catalytic ink (e.g., ink 880), that may serve as a seed layer for electroless plating, immersion bathing, or other metallization process subsequent to flexographic printing operations. In certain embodiments, the pre-metallized base pattern 1110 may be a cross-hatched fill pattern as depicted in FIG. 11A. The cross-hatched fill pattern may provide improved redundancy and fault tolerance as a result of the cross-hatching. In other embodiments, the pre-metallized base pattern 1110 may be a solid fill pattern (not shown). One of ordinary skill in the art will recognize that other fill patterns may be used in accordance with one or more embodiments of the present invention. One of ordinary skill in the art will also recognize that the pre-metallized base pattern 1110 may vary based on an application or design in accordance with one or more embodiments of the present invention.

Continuing in FIG. 11B, a portion 1105 of a pre-metallized base pattern 1110 with a flexographically printed void 1120 pattern of dielectric ink (not independently illustrated) is shown in accordance with one or more embodiments of the present invention. One or more flexographic print stations (e.g., flexographic printing station 800) may be used to print a void 1120 pattern of dielectric ink that resists metallization on at least a portion of the pre-metallized base pattern 1110. Each void 1120 may be a line, a square, a rectangle, a polygon, or any other shape that may vary based on an application or design. The size of the voids 1120 and the pattern in which they are arranged may also vary based on an application or design. However, in certain embodiments, it may be desirable to print voids 1120 having well-defined feature sizes that prevent failure from, for example, catalytic ink migration, catalytic ink smearing, or other failure modes that may give rise to electrical shorts or breaks. For example, in the embodiment depicted in FIG. 11B, the void 1120 pattern may be used as part of a process to partition the pre-metallized base pattern 1110 into a plurality of interconnect conductive lines (e.g., interconnect conductive lines 550 of FIG. 5) of a bezel circuit. In such an embodiment, the void 1120 pattern may be designed such that the voids 1120 are printed over portions of the pre-metallized base pattern 1110. The voids 1120 may have a feature size such as, for example, a line width, that varies based on an application or design. In certain embodiments, the voids 1120 may have a line width less than 5 micrometers. In other embodiments, the voids 1120 may have a line width in a range between approximately 5 micrometers and approximately 10 micrometers. In still other embodiments, the voids 1120 may have a line width in a range between approximately 10 micrometers and approximately 50 micrometers. In still other embodiments, the voids 1120 may have a line width larger than approximately 50 micrometers. One of ordinary skill in the art will recognize that the line width of the voids 1120 may vary based on an application or design in accordance with one or more embodiments of the present invention.

In certain embodiments, the void 1120 pattern may be flexographically printed with dielectric ink. One of ordinary skill in the art will recognize the composition of the dielectric ink may vary based on an application or design and other dielectric inks may be used so long as they resist metallization. Resistance to metallization means that, when the substrate is subjected to a metallization process, including, for example, an electroless plating process, an immersion bathing process, or other metallization process, the voids 1120 prevent the catalytic material, or catalytic ink, on which they are disposed from being metallized. While in certain embodiments, the dielectric ink may be color matched to a metal used to metalize the exposed catalytic material, in the embodiment depicted in FIG. 11B, the bezel circuitry is typically disposed outside the viewable area of the touch sensor and as such color matching may not be required.

Continuing in FIG. 11C, a portion 1105 of a metallized conductive pattern with electrically isolated interconnect conductive lines 550 is shown in accordance with one or more embodiments of the present invention. Subsequent to the flexographic printing of the void 1120 pattern, the substrate may be subjected to a metallization process including, for example, an electroless plating process, an immersion bathing process, or other metallization process. The metallization process metallizes the exposed portions of the catalytic material, or catalytic ink, which are not covered by the void 1120 pattern. The voids 1120 prevent the catalytic material, or catalytic ink, on which they are disposed from being metallized. As such, in the embodiment depicted in FIG. 11C, the void 1120 pattern partitions the metallized base pattern 1110 into a plurality of electrically isolated interconnect conductive lines 550 as part of the bezel circuit. At the bottom of FIG. 11C, each interconnect conductive line 550 may connect to a channel pad (e.g., channel pad 540 of FIG. 5A) that connects to a column channel (e.g., column channel 310). At the left side of FIG. 11C, each interconnect conductive line 550 may connect to an interface connector (e.g., interface connector 560 of FIG. 5A). In this way, the voids 120 may be used to form well-defined non-conductive gaps that are not susceptible to common failure modes resulting from the use of catalytic ink.

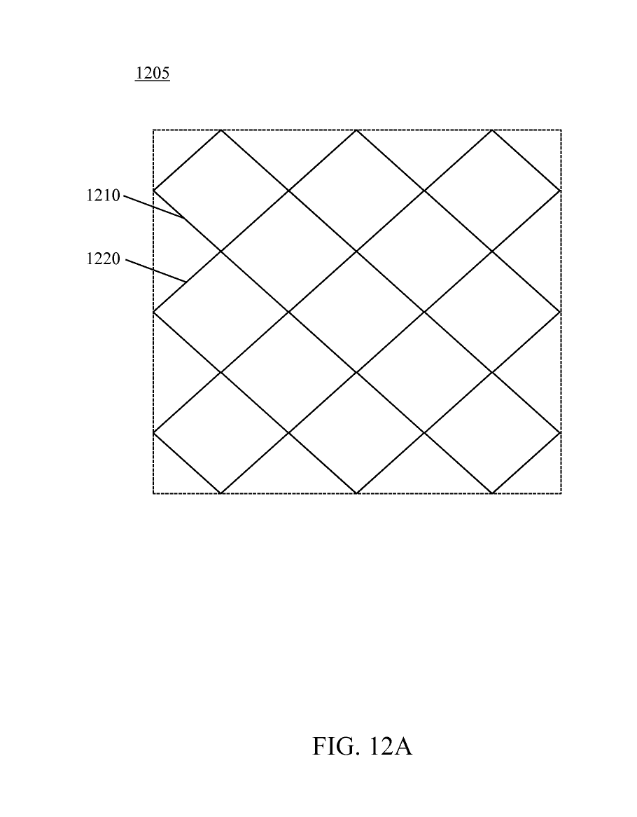

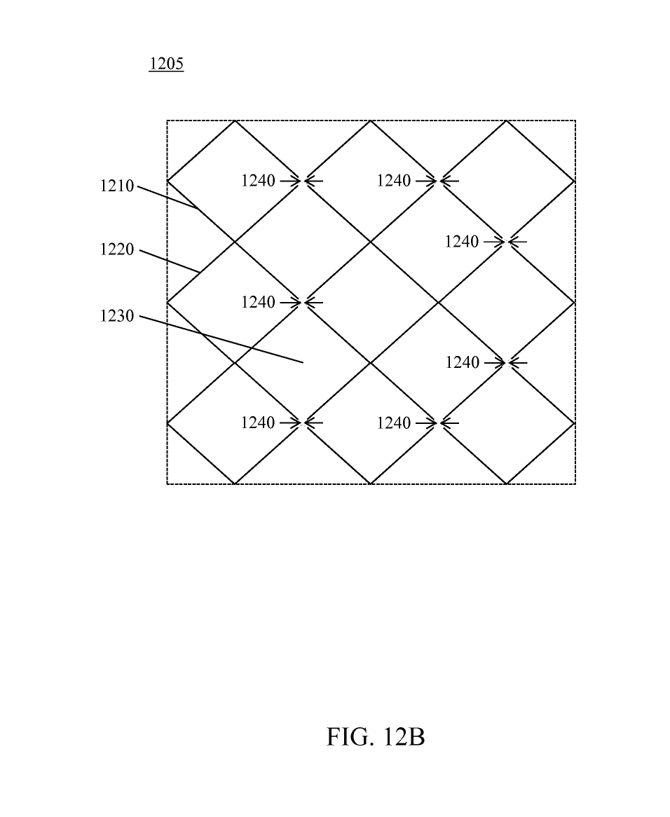

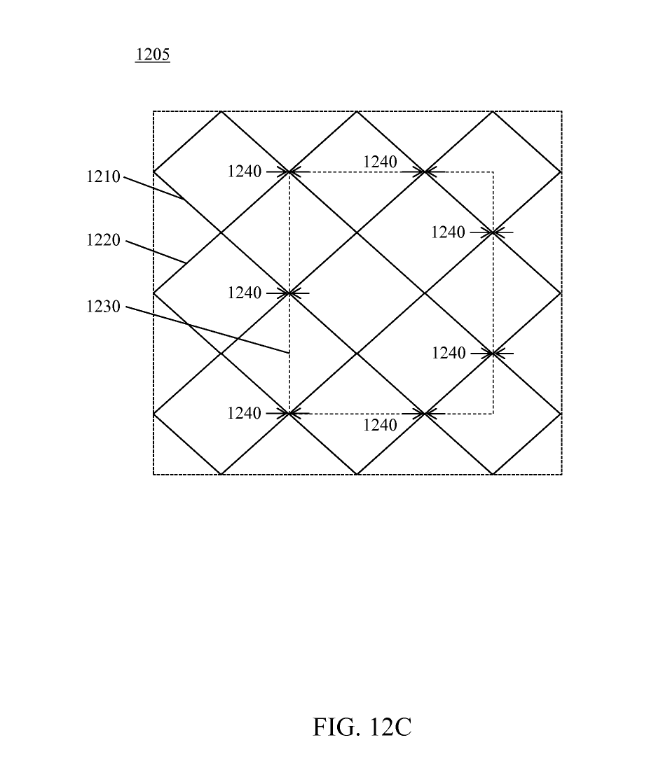

FIG. 12A shows a portion 1205 of a pre-metallized image of a conductive pattern (e.g., first conductive pattern 420) disposed on a substrate (e.g., transparent substrate 410) in accordance with one or more embodiments of the present invention. A pre-metallized image of a conductive pattern, also referred to as a base pattern, may be disposed on a substrate using any process suitable for disposing the image on the substrate, including, for example, a flexographic printing process. In flexographic embodiments, the pre-metallized image may be flexographically printed on the substrate using a catalytic material such as, for example, a precursor or catalytic ink (e.g., ink 880), that may serve as a seed layer for electroless plating, immersion bathing, or other metallization process subsequent to flexographic printing operations. The pre-metallized image of the conductive pattern may include an image 1210 of a plurality of parallel conductive lines oriented in a first direction (e.g., parallel conductive lines 510) and an image 1220 of a plurality of parallel conductive lines oriented in a second direction (e.g., parallel conductive lines 520). One of ordinary skill in the art will recognize that the pre-metallized image of the conductive pattern may vary based on an application or design in accordance with one or more embodiments of the present invention.

However, in certain applications or designs, it may be desirable to carve out one or more dummy portions (not shown) from the conductive pattern. These dummy portions are isolated from the remainder of the conductive pattern, but are included to reduce the visibility of the conductive pattern as a whole. For example, while dummy portions may not serve an electrical purpose, if they were removed, their absence would create a contrast that would draw attention to the remaining portions of the conductive pattern, rendering the conductive pattern as a whole more visibly apparent (which is undesirable in touch sensor applications). For that reason, dummy portions are typically left in place despite the fact that they are electrically isolated from the remainder of the conductive pattern. While the inclusion of the dummy portions helps reduce contrast, subsequent to metallization, the dummy portions tend to be of a different color or have a different reflectivity, once again giving rise to contrast that draws attention to the remaining portions of the conductive pattern, rendering the conductive pattern as a whole more visibly apparent. As such, a flexographically printed void pattern may be used to form the dummy portion, isolating the dummy portion from the remainder of the conductive pattern, but having the same visible appearance as the remainder of the conductive pattern so as to reduce the visibility of the conductive pattern as a whole post-metallization.

Continuing in FIG. 12B, a flexographically printed void 1240 pattern of dielectric ink (not independently illustrated) is shown in accordance with one or more embodiments of the present invention. One or more flexographic print stations (e.g., flexographic printing station 800) may be used to print a plurality of voids 1240 of dielectric ink that resist metallization on at least a portion of the pre-metallized image of the conductive pattern. Each void 1240 may be a line, a square, a rectangle, a polygon, or any other shape that may vary based on an application or design. The size of the void 1240 and the pattern in which they are arranged may also vary based on an application or design. However, in certain embodiments, such as, for example, touch sensor applications, it may be desirable to print voids 1240 having very small feature sizes. For example, in the embodiment depicted in FIG. 12B, the void 1240 pattern may be used to form breaks that isolate a dummy portion 1230 of the conductive pattern from the remainder of the conductive pattern. In such an embodiment, the void 1240 pattern may be designed such that the voids 1240 are printed over one or more intersections formed by the images 1210 and 1220 of one or more parallel conductive lines oriented in the first direction and one or more parallel conductive lines oriented in the second direction. Because the images of the conductive lines are micrometer-fine, the voids 1240 may also be micrometer-fine. Advantageously, the visibility of the voids 1240 may be reduced as their feature size decreases. In certain embodiments, the voids 1240 may have a line width less than 5 micrometers. In other embodiments, the voids 1240 may have a line width in a range between approximately 5 micrometers and approximately 10 micrometers. While an advantage of the flexographically printed voids 1240 is the ability to form high-resolution non-conductive gaps, one of ordinary skill in the art will recognize that the voids could have a line width larger than 10 micrometers that may be used in other applications or designs in accordance with one or more embodiments of the present invention.

In certain embodiments, the void 1240 pattern may be flexographically printed with dielectric ink. One of ordinary skill in the art will recognize that the composition of the dielectric ink may vary based on an application or design and other dielectric inks may be used so long as they resist metallization. Resistance to metallization means that, when the substrate is subjected to a metallization process, including, for example, an electroless plating process, an immersion bathing process, or other metallization process, the voids 1240 prevent the catalytic material, or catalytic ink, on which they are disposed from being metallized. In certain embodiments, the dielectric ink may have a color that matches a color of a metal used to metalize the exposed catalytic material.

Continuing in FIG. 12C, a portion 1205 of a metallized conductive pattern with electrically isolated dummy portion 1230 is shown in accordance with one or more embodiments of the present invention. Subsequent to the flexographic printing of the plurality of voids 1240, the substrate may be subjected to a metallization process including, for example, an electroless plating process, an immersion bathing process, or other metallization process. The metallization process metallizes the exposed portions of the catalytic material, or catalytic ink, which are not covered by the void 1240 pattern. The voids 1240 prevent the catalytic material, or catalytic ink, on which they are disposed from being metallized. As such, in the embodiment depicted in FIG. 12C, the void 1240 pattern may form a dummy portion 1230 carved out, and electrically isolated, from the conductive pattern even though it gives the appearance of being connected and uniform. Because the dielectric ink was color matched to the color of the metal used to metalize the exposed catalytic material, there is no visible break in the conductive pattern, even though the voids 1240 electrically isolated the dummy portion 1230 from the remainder of the conductive pattern. Thus, the visibility of the dummy portion is reduced or eliminated and the visibility of the conductive pattern itself is substantially reduced.

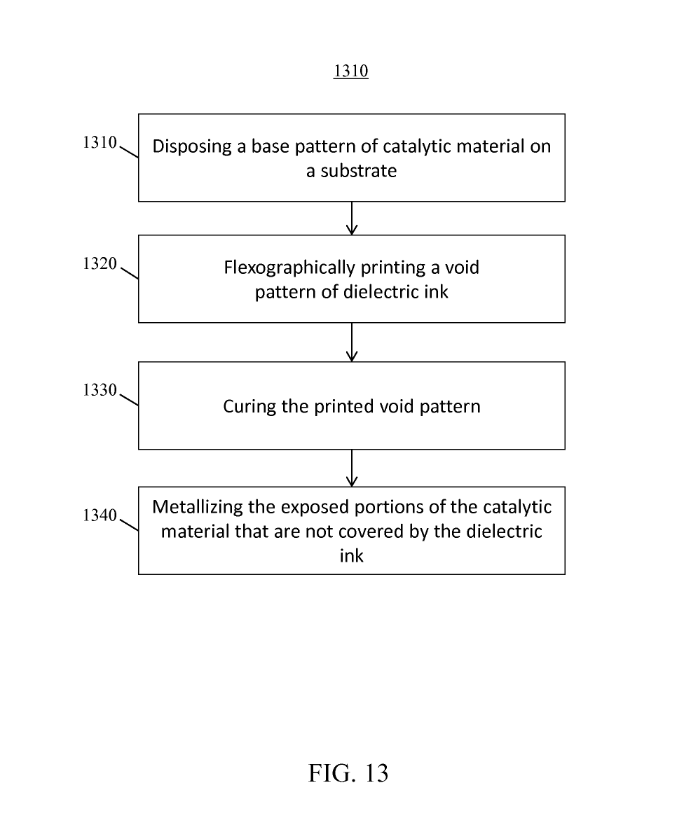

FIG. 13 shows a method 1300 of fabricating electrically isolated conductors using flexographic voiding in accordance with one or more embodiments of the present invention.

In step 1310, a base pattern may be disposed on a substrate. The base pattern may comprise a catalytic material such as, for example, catalytic ink. In certain embodiments, the base pattern may be disposed on the substrate using a flexographic printing process. The flexographic printing process may use one or more flexographic printing stations or a multi-station flexographic printing system in accordance with one or more embodiments of the present invention. For example, one or more flexographic printing stations may be used to dispose a catalytic ink image of the base pattern on the substrate. In other embodiments, the base pattern may be disposed on the substrate using one or more of gravure printing, inkjet printing, rotary printing, or stamping. In still other embodiments, the base pattern may be disposed on the substrate using one or more of pattern based deposition, chemical vapor deposition, electro deposition, epitaxy, physical vapor deposition, or casting. In still other embodiments, the base pattern may be disposed on the substrate using one or more of optical photolithography, UV-based photolithography, e-beam lithography, ion-beam lithography, x-ray lithography, interference lithography, scanning probe lithography, imprint lithography, or magneto lithography. In certain embodiments, the base pattern may comprise a mesh formed by an image of a plurality of parallel conductive lines oriented in a first direction and an image of a plurality of parallel conductive lines oriented in a second direction. In other embodiments, the base pattern may comprise a cross-hatched fill pattern. In still other embodiments, the base pattern may comprise a solid fill pattern. One of ordinary skill in the art will recognize that the base pattern may vary in accordance with one or more embodiments of the present invention. One of ordinary skill in the art will also recognize that the base pattern may be any pattern of catalytic material disposed on a substrate in accordance with one or more embodiments of the present invention.

In step 1320, a void pattern of dielectric ink that resists metallization may be flexographically printed on a portion of the base pattern. One or more flexographic printing stations or a multi-station flexographic printing system may be used to print the void pattern using dielectric ink that resists metallization over at least a portion of the base pattern. In certain embodiments, the void pattern may comprise a plurality of channel break voids that are used to partition the base pattern into a plurality of electrically isolated channels as part of, for example, a touch sensor application. In other embodiments, the void pattern may comprise a plurality of conductor voids that are used to electrical isolate conductors disposed on either side of the void. In this way, the plurality of conductor voids may be used to fabricate isolated conductors for use in many applications. In certain embodiments, the dielectric ink may comprise a non-catalytic ink that is not susceptible to metallization including when, for example, it is submerged in an electroless plating bath. One of ordinary skill in the art will recognize the composition of the dielectric ink may vary based on an application or design and other dielectric inks may be used so long as they resist metallization.

In step 1330, the printed void pattern may optionally be cured. In certain embodiments, where the dielectric ink is, for example, composed of UV-curable material, the printed void pattern may be UV-cured to achieve an appropriate amount of cross-linking. The printed void pattern may be UV-cured by exposing the void pattern to UV radiation of an appropriate wavelength for an amount of time suitable to cross-link the dielectric ink. The UV radiation may be provided after completion of flexographic printing operations, but prior to metallization.

In step 1340, the exposed portions of the catalytic material, that are not covered by the printed dielectric ink, are metallized. In certain embodiments, the exposed portions of the catalytic material may be metallized by electrolessly plating the exposed portions of the catalytic material with a metal. The metal may comprise one or more of copper, nickel, palladium, other platinum group metals, bismuth, gold, silver, cobalt, chromium, composites, or alloys thereof. In other embodiments, the exposed portions of the catalytic material may be metallized by electrolessly plating the exposed portions of the catalytic material with a first metal and electrolessly plating the plated first metal with a second metal. In certain embodiments, such as, for example, certain touch sensor applications, the first metal may comprise copper and the second metal may comprise nickel or palladium. The copper metal layer may provide sufficient conductivity for connectivity whereas the nickel or palladium layer may reduce the color visibility of the plated copper or passivate the plated copper. One of ordinary skill in the art will recognize that other combinations of metals or metal alloys may be used in accordance with one or more embodiments of the present invention. In still other embodiments, the exposed portions of the catalytic material may be metallized by immersion bathing the exposed portions of the catalytic material with a metal. One of ordinary skill in the art will recognize the exposed portions of the catalytic material may be metallized by other metallization processes that deposit metal on the exposed portions of the catalytic material in accordance with one or more embodiments of the present invention.

Advantages of one or more embodiments of the present invention may include one or more of the following:

In one or more embodiments of the present invention, a method of fabricating isolated conductors using flexographic voiding simplifies the design of a base pattern. In conventional applications, individual conductors are typically formed independently of each other and any issue related to their formation may give rise to performance related issues such as, for example, electrical opens and electrical shorts. As the number of conductors increases, the probability of failures also increases. In contrast, the method of fabricating isolated conductors using flexographic voiding may use a comparatively simple base pattern or one that provides redundancy. The flexographically printed void pattern affirmatively establishes where conductivity and connectivity are not desired that is not prone to ink migration, smearing, or other failure modes. As such, high-resolution and well-defined voids may be formed, resulting in high-resolution and well-defined non-conductive gaps between isolated conductors.

In one or more embodiments of the present invention, a method of fabricating isolated conductors using flexographic voiding may be used to partition a conductive pattern into a plurality of electrically isolated channels using channel breaks that are not visibly apparent. The voids may be printed with a dielectric ink that may be color matched to the color of a metal used to metallized the exposed portions of catalytic material or to the color of a passivation layer that may be applied after metallization. In either case, the fabricated conductive pattern includes a plurality of channels that are electrically isolated, but appear visibly connected, because of the color matched dielectric ink. As such, the human eye does not integrate or otherwise recognize the pattern of the gaps traditionally used to form conventional channel breaks.

In one or more embodiments of the present invention, a method of fabricating isolated conductors using flexographic voiding may be used to partition any base pattern into isolated conductors. A base pattern, such as, for example, a solid fill pattern, a cross-hatched fill pattern, or a mesh pattern may be partitioned into a plurality of isolated conductors by a flexographically printed void pattern that prevents the metallization of the void pattern by a metallization process.

In one or more embodiments of the present invention, a method of fabricating isolated conductors using flexographic voiding reduces manufacturing expense, manufacturing time, and manufacturing complexity.

In one or more embodiments of the present invention, a method of fabricating isolated conductors using flexographic voiding is compatible with existing flexographic printing processes.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of fabricating isolated conductors using flexographic voiding comprising:
disposing a base pattern of catalytic material on a substrate;
flexographically printing a void pattern of dielectric ink that resists metallization on a portion of the base pattern; and
metallizing exposed portions of the catalytic material that are not covered by the dielectric ink.

2. The method of claim 1, further comprising:
curing the printed void pattern.

3. The method of claim 1, wherein the base pattern is disposed on the substrate using a flexographic printing process.

4. The method of claim 1, wherein the base pattern is disposed on the substrate using gravure printing, inkjet printing, rotary printing, or stamping.

5. The method of claim 1, wherein the base pattern is disposed on the substrate using pattern-based deposition, chemical vapor deposition, electro deposition, epitaxy, physical vapor deposition, or casting.

6. The method of claim 1, wherein the base pattern is disposed on the substrate using optical photolithography, UV-based photolithography, e-beam lithography, ion-beam lithography, x-ray lithography, interference lithography, scanning probe lithography, imprint lithography, or magneto lithography.

7. The method of claim 1, wherein the catalytic material comprises a catalytic ink.

8. The method of claim 1, wherein the base pattern comprises a mesh formed by an image of a plurality of parallel conductive lines oriented in a first direction and an image of a plurality of parallel conductive lines oriented in a second direction.

9. The method of claim 1, wherein the base pattern comprises solid fill pattern.

10. The method of claim 1, wherein the base pattern comprises a cross-hatched fill pattern.

11. The method of claim 1, wherein the void pattern comprises a plurality channel break voids.

12. The method of claim 1, wherein the void pattern comprises a plurality of conductor voids.

13. The method of claim 1, wherein the dielectric ink comprises a non-catalytic ink.

14. The method of claim 1, wherein the dielectric ink comprises a non-catalytic ink that resists metallization.

15. The method of claim 1, wherein the dielectric ink is color matched to a color of a metal used to metallize the exposed portions of the catalytic material.

16. The method of claim 1, wherein metallizing the exposed portions of the catalytic material comprises electrolessly plating the exposed portions of the catalytic material with a metal.

17. The method of claim 16, wherein the metal comprises one or more of copper, nickel, palladium, other platinum group metals, bismuth, gold, silver, cobalt, chromium, composites, or alloys thereof.

18. The method of claim 1, wherein metallizing the exposed portions of the catalytic material comprises electrolessly plating the exposed portions of the catalytic material with a first metal and electrolessly plating the plated first metal with a second metal.

19. The method of claim 18, wherein the first metal comprises copper and the second metal comprises palladium.

20. The method of claim 1, wherein metallizing the exposed portions of the catalytic material comprises immersion bathing the exposed portions of the catalytic material.
